(19) United States
(12) Patent Application Publication
(10) Pub. No.: US 2021/0305547 A1
(43) Pub. Date: Sep. 30, 2021

(54) CONTACT PLATE ARRANGEMENT

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wustenrot (DE); Claus Gerald PFLÜGER, Markgroningen (DE); Moritz CONZE, Laufach (DE); Jacob TREMMEL, Bietigheim-Bissingen (DE)

(21) Appl. No.: 16/834,081

(22) Filed: Mar. 30, 2020

(51) Int. Cl. H01M 2/20; H01M 2/10; H01M 2/22; H01M 2/30; H01M 10/42

(52) U.S. Cl. CPC H01M 2/206; H01M 2/1077; H01M 2/22; H01M 2220/00; H01M 10/425; H01M 2200/103; H01M 2/305

(57) ABSTRACT

An embodiment is directed to a contact plate arrangement for a battery module. In an aspect, the contact plate arrangement includes a busbar configured to transport current between first and second parallel groups of battery cells (P-Groups) in series, and a bonding connector attached to a sidewall of the busbar and configured to form an electrical connection with a cell terminal of a battery cell from a respective one of the first and second P-Groups.

### BACKGROUND

### 1. Field of the Disclosure

Embodiments relate to contact plate arrangements, and more particularly, to contact plate arrangements comprising a contact plate arrangement where a bonding connector is attached or affixed to a sidewall of a busbar.

### 2. Description of the Related Art

Energy storage systems may rely upon battery cells for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

An embodiment is directed to a contact plate arrangement for a battery module. In an aspect, the contact plate arrangement includes a busbar configured to transport current between first and second parallel groups of battery cells (P-Groups) in series, and a bonding connector attached to a sidewall of the busbar and configured to form an electrical connection with a cell terminal of a battery cell from a respective one of the first and second P-Groups.

Other objects and advantages associated with the aspects disclosed herein will be apparent to those skilled in the art based on the accompanying drawings and detailed description.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of a battery module that shows P groups 1 . . . N connected in series in accordance with an embodiment of the disclosure.

FIG. 3 illustrates a battery module during assembly after battery cells are inserted therein.

FIGS. 4A-4C illustrate the general arrangement of contact plate(s) with respect to battery cells of a battery module.

FIG. 5 illustrates an example of the layers of a conventional multi-layer contact plate.

FIG. 6 illustrates a contact plate arrangement for a battery module in accordance with an embodiment of the disclosure.

FIG. 7 illustrates a battery module that comprises the contact plate arrangement of FIG. 6.

FIG. 8 illustrates a contact plate arrangement for a battery module in accordance with an embodiment of the disclosure.

FIG. 9 illustrates the flow of current across the respective contact plates of contact plate arrangement of FIG. 8.

FIG. 10 illustrates a battery module that comprises the contact plate arrangement of FIG. 8.

FIG. 11 illustrates a contact plate arrangement in accordance with another embodiment of the disclosure.

FIGS. 12A-12B illustrate conventional positive cell terminal connection configurations before and after welding of a respective bonding connector to a positive cell terminal of a battery cell.

FIGS. 13A-13B illustrate positive cell terminal connection configurations before and after welding of a respective bonding connector to a positive cell terminal of a battery cell in accordance with an embodiment of the disclosure.

FIGS. 14A-14B illustrate an example of fabricating the arrangement of the busbar and bonding connector as shown in FIGS. 13A-13B in accordance with an embodiment of the disclosure.

FIGS. 15A-15B illustrate an example of fabricating the arrangement of the busbar and bonding connector as shown in FIGS. 13A-13B in accordance with another embodiment of the disclosure.

FIGS. 16A-16B illustrate positive cell terminal connection configurations before and after welding of a respective bonding connector to a positive cell terminal of a battery cell in accordance with another embodiment of the disclosure.

FIGS. 17A-17B illustrate an example of fabricating the arrangement of the busbar and bonding connector parts as shown in FIGS. 16A-16B in accordance with an embodiment of the disclosure.

FIGS. 18A-18B illustrate an example of fabricating the arrangement of the busbar and bonding connector parts as shown in FIGS. 16A-16B in accordance with another embodiment of the disclosure.

FIGS. 19A-19B illustrate positive cell terminal connection configurations before and after welding of a respective bonding connector to a positive cell terminal of a battery cell in accordance with another embodiment of the disclosure.

FIGS. 20A-20B illustrate positive cell terminal connection configurations before and after welding of a respective bonding connector to a positive cell terminal of a battery cell in accordance with another embodiment of the disclosure.

FIGS. 21A-21B illustrate positive cell terminal connection configurations before and after welding of a respective bonding connector to a positive cell terminal of a battery cell in accordance with another embodiment of the disclosure.

FIGS. 22A-22B illustrate positive cell terminal connection configurations before and after welding of a respective bonding connector to a positive cell terminal of a battery cell in accordance with another embodiment of the disclosure.

FIGS. 23A-23B depict the busbar arrangements from FIGS. 14B and 17B, respectively, in accordance with embodiments of the disclosure.

FIG. 24 illustrates a bonding connector with a busbar interface part (e.g., tacked or glued to a respective sidewall of a busbar), a fuse area and a non-fuse area in accordance with an embodiment of the disclosure.

FIGS. 25A-25E illustrate alternative fuse areas in accordance with embodiments of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

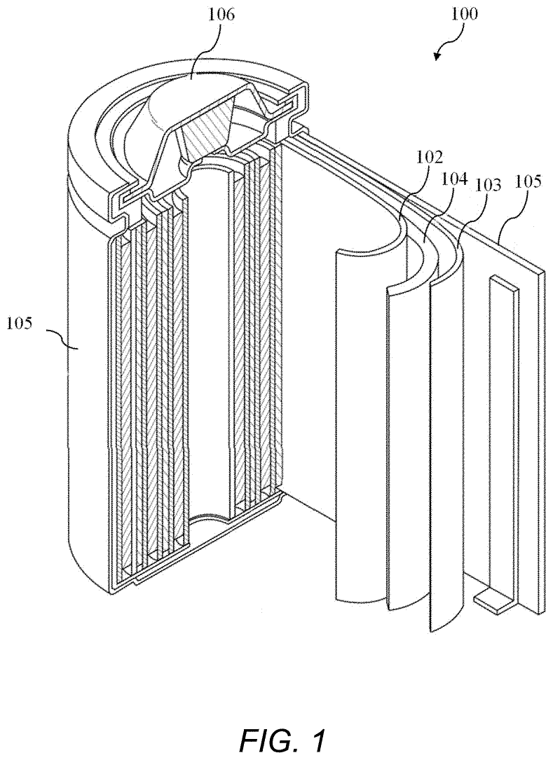

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

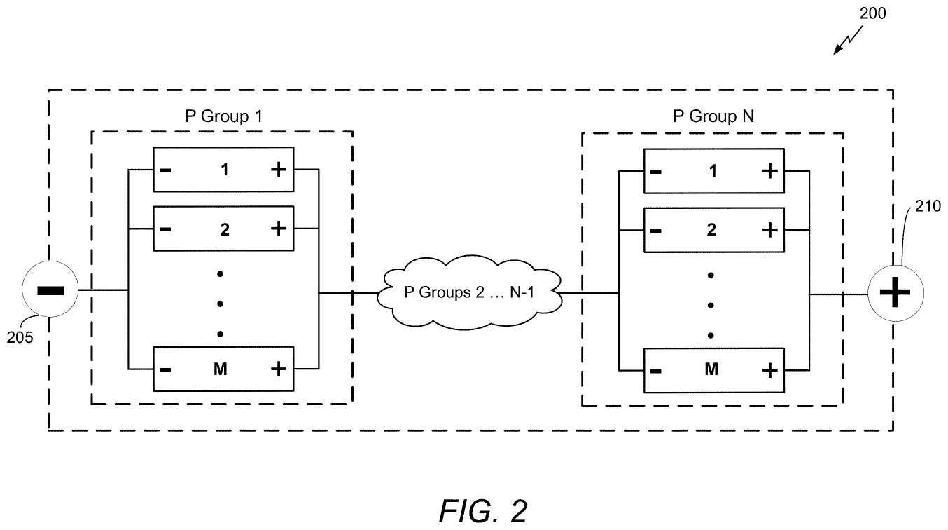

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

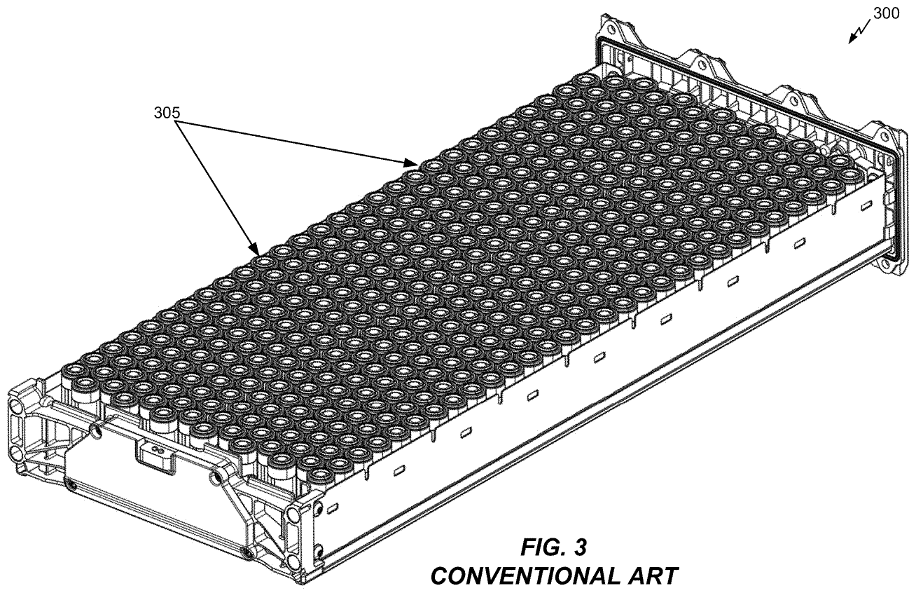

FIG. 3 illustrates a battery module 300 during assembly after battery cells 305 are inserted therein. In some designs, both the positive terminal (cathode) and negative terminal (anode) of the battery cells in the battery module 300 may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

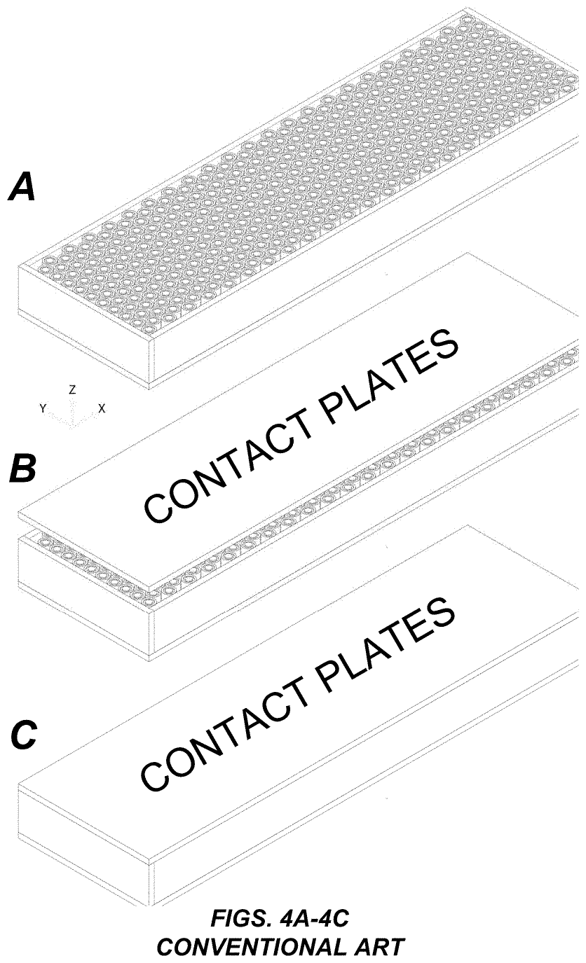

FIGS. 4A-4C illustrate the general arrangement of contact plate(s) with respect to battery cells of a battery module. As shown in FIGS. 4A-4C, the contact plates may be arranged on top of the battery cells in close proximity to their respective positive and negative terminals in some designs.

There are a variety of ways in which the above-noted contact plates may be configured. For example, the contact plates can be configured as solid blocks of aluminum or copper, whereby bonding connectors are spot-welded between the contact plates and the positive and negative terminals of the battery cells. Alternatively, a multi-layer contact plate that includes an integrated cell terminal connection layer may be used.

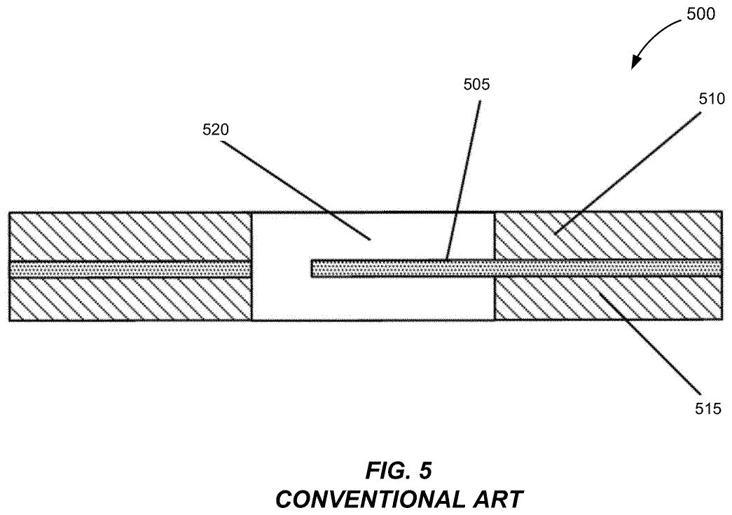

FIG. 5 illustrates an example of the layers of a conventional multi-layer contact plate 500. In FIG. 5, the multi-layer contact plate 500 includes a flexible cell terminal connection layer 505 that is sandwiched between a top conductive plate 510 and a bottom conductive plate 515. In an example, the top and bottom conductive plates 510 and 515 may be configured as solid Cu or Al plates (e.g., or an alloy of Cu or Al), while the flexible cell terminal connection layer 505 is configured as foil (e.g., steel or Hilumin foil). A number of openings, such as opening 520, are punched into the top and bottom conductive plates 510 and 515, while some part of the flexible cell terminal connection layer 505 extends out into the opening 520. During battery module assembly, the part of the flexible cell terminal connection layer 505 that extends into the opening 520 can then be pressed downward so as to contact a positive or negative terminal of one or more battery cells arranged underneath the opening 520, and then welded to obtain a mechanically stable plate-to-terminal electrical connection.

Referring to FIG. 5, the layers of the multi-layer contact plate 500 may be joined via soldering or brazing (e.g., based on soldering or brazing paste being arranged between the respective layers before heat is applied), which results in soldering or brazing “joints” between the respective layers. These joints provide both (i) an inter-layer mechanical connection for the multi-layer contact plate 500, and (ii) an inter-layer electrical connection for the multi-layer contact plate 500.

Referring to FIG. 5, one of the advantages of configuring the flexible cell terminal connection layer 505 with a different material (e.g., steel or Hilumin) than the surrounding top and bottom conductive plates 510 and 515 (e.g., Cu, Al, or an alloy thereof) is so that the cell terminal connections can be welded via like metals. For example, it is common for cell terminals to be made from steel or Hilumin. However, steel is not a particularly good conductor. Hence, the top and bottom conductive plates 510 and 515 are made from a more conductive material (e.g., Cu, Al, or an alloy thereof) than steel, while steel is used in the flexible cell terminal connection layer 505 to avoid disparate metals being welded together for the cell terminal connection.

In an alternative embodiment to the contact plate configuration depicted in FIG. 5, instead of two solid plates sandwiching a foil terminal connection layer, a contact plate (e.g., Cu, Al, or an alloy thereof, although it is possible for the contact plate to be multi-layer) can be coated with a thin layer of a different metal (e.g., steel or Hilumin) that is suitable to be welded to one or more battery cell terminals. The coated contact plate can be locally punched or etched to define specific sections that (i) can be moved flexibly, or (ii) can be configured as a fuse, or (iii) can be made suitable for welding to the battery cell terminal(s).

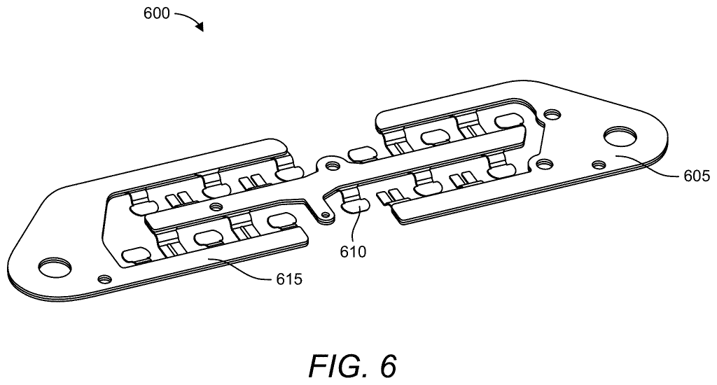

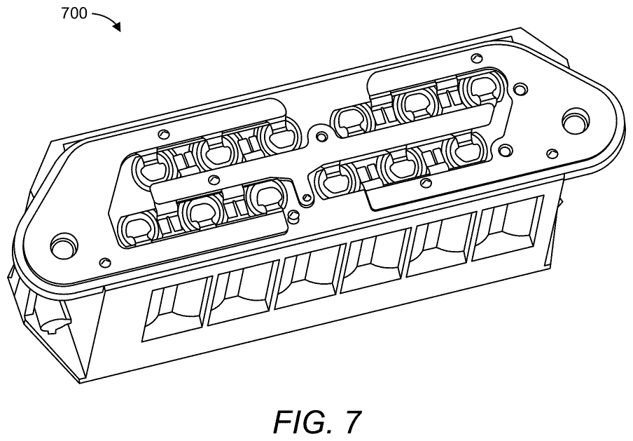

FIG. 6 illustrates a contact plate arrangement 600 for a battery module in accordance with an embodiment of the disclosure. The contact plate arrangement 600 is configured with single-level contact plate configuration. In the example of FIG. 6, each respective contact plate may be configured as the multi-layer contact plate 500 (e.g., top/bottom plates sandwiching a flexible cell terminal connection layer). As used herein, contact plates being arranged in a single-level means that the contact plates do not overlap (or stack) with each other, and thereby do not require ‘vertical’ electrical insulation layers (although insulation may be arranged to provide ‘horizontal’ electrical insulation). In particular, the contact plate arrangement 600 includes a “negative pole” contact plate 605, a “center” contact plate 610, and a “positive pole” contact plate 615. The contact plate arrangement 600 is configured to chain two distinct P-Groups (i.e., distinct parallel groups of battery cells as described above with respect to FIG. 2) together in series. To this end, the “negative pole” contact plate 605 includes a set of negative bonding connectors for connecting to a set of negative cell terminals of P-Group 1, the “center” contact plate 610 includes a set of positive bonding connectors for connecting to a set of positive cell terminals of P-Group 1 as well as a set of negative bonding connectors for connecting to a set of negative cell terminals of P-Group 2, and the “positive pole” contact plate 615 includes a set of positive bonding connectors for connecting to a set of positive cell terminals of P-Group 2. FIG. 7 illustrates a battery module 700 that comprises the contact plate arrangement 600 of FIG. 6.

In the embodiment of FIGS. 6-7, the contact plate arrangement 600 connects a total of 12 battery cells together, with 6 battery cells per P-Group. In an example, the contact plates 605-615 may be arranged as multi-layer contact plates (e.g., top/bottom plates made from Aluminum sandwiching a steel layer (Hilumin), with each multi-layer contact plate having a total average thickness of about 1.8 mm).

Some embodiments of the present disclosure are directed to contact plate arrangements with three or more contact plate levels. By using additional contact plate levels, the number of battery cells in each P-Group can be reduced relative to the contact plate arrangement 600, and the overall thickness of each contact plate can also be reduced relative to the contact plate arrangement 600. Moreover, in some designs, such contact plates may be produced without soldering/brazing.

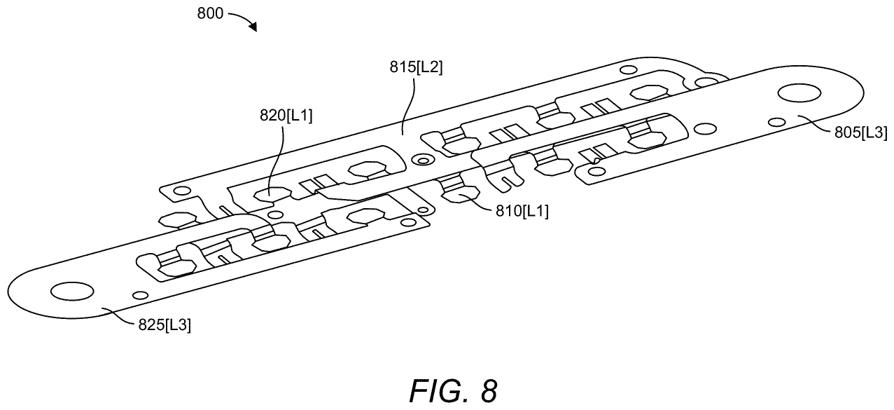

FIG. 8 illustrates a contact plate arrangement 800 for a battery module in accordance with an embodiment of the disclosure. The contact plate arrangement 800 is configured with three-level contact plate configuration. In particular, the contact plate arrangement 800 includes a “negative pole” contact plate 805[L3], center contact plates 810[L1], 815[L2] and 820[L1], and “positive pole” contact plate 825[L3], whereby L1 denotes contact plate level 1, L2 denotes contact plate level 2, and L3 denotes contact plate level 3.

As shown in FIG. 8, a respective contact plate may be ‘partially’ stacked (e.g., arranged over in vertical of Z direction) over contact plate(s) of lower contact plate level(s) with part of the respective contact plate (in an overlapped area) being arranged over the contact plate(s) of the lower contact plate level(s). As used herein, a ‘higher’ contact plate level may generally be characterized as further away from the cell terminals to which the respective contact plates are connected, and a ‘lower’ contact plate level may generally be characterized as further away from the cell terminals to which the respective contact plates are connected. In some designs, in non-overlapping areas, a contact plate in a higher level may dip to or below the ‘height’ of a contact plate in a lower level. Also, some contact plate components (e.g., bonding connectors) may extend downwards beneath contact plate(s) in lower levels.

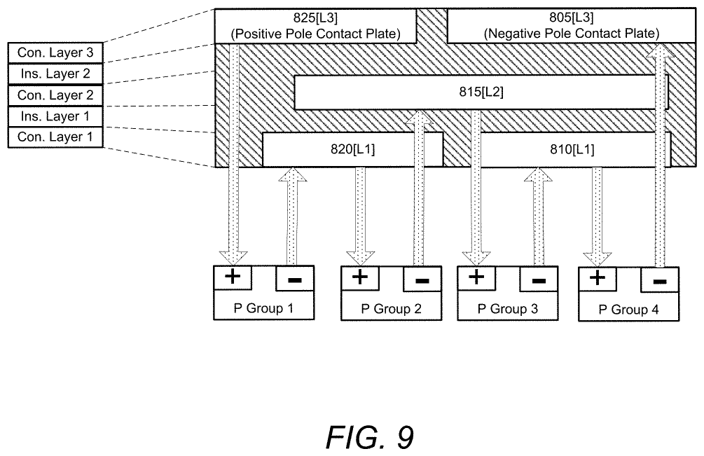

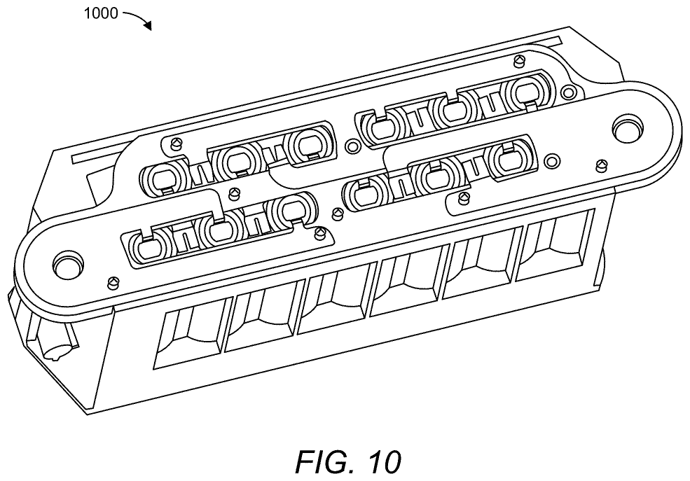

The flow of current across the respective contact plates of contact plate arrangement 800 of FIG. 8 is depicted in FIG. 9. FIG. 10 illustrates a battery module 1000 that comprises the contact plate arrangement 800 of FIG. 8.

In the embodiment of FIG. 8, the contact plate arrangement 800 connects a total of 12 battery cells together, with 3 battery cells per P-Group (i.e., P-Groups 1, 2, 3 and 4). In other designs, a different number of battery cells per P-Group may be implemented (e.g., 4 battery cells per P-Group, 5 battery cells per P-Group, etc.). In some designs, each contact plate of the contact plate arrangement 800 may be made thinner (on average) relative to the contact plates of the contact plate arrangement 600 (on average). For example, the contact plate arrangement 600 may be arranged with multi-layer contact plates (e.g., top/bottom plates made from Aluminum sandwiching an steel or Hilumin layer, with each multi-layer contact plate having a total average thickness of about 1.8 mm), whereas the contact plate arrangement 800 may be arranged with thinner contact plates (e.g., single plates of Steel (Hilumin) or Aluminum or Copper or a sandwich out of these layers). As will be explained below in more detail, in some designs, the use of three thinner contact plate levels instead of one thick contact plate level can reduce the overall thickness of the contact plate arrangement. However, in other designs, contact plate arrangements with fewer levels (e.g., one or two) can be used.

As will be appreciated, chaining more P-Groups together in series functions to increase the voltage of an associated battery module. So, while FIGS. 8-10 are directed to a battery module that includes four P-Groups (with three cells per P-Group), additional P-Groups may be added for higher voltage applications.

In other embodiments, adjacent series-connected P-Groups may be connected to respective contact plate levels in different sequences (e.g., L3-L2-L1-L3-L2-L1, etc.). In other embodiments, the positive pole and/or negative pole contact plates can be arranged at other levels (e.g., L2 or L1) as opposed to the L3 level. In other designs, additional levels (e.g., L4, L5, etc.) may be added, and the various level changes between adjacent P-Groups can correspond to any possible sequence (e.g., L1-L2-L3-L5-L4, L1-L3-L5-L2-L4, etc.) and likewise the positive/negative pole contact plates can be arranged at any level (e.g., L1, L2, L3, L4, L5, etc.).

As noted above, the multi-level contact plate structure (for a three-level contact plate arrangement) may be characterized in terms of first, second and third contact plate levels, whereby multiple contact plates may belong to each respective contact plate level. Generally, a so-called ‘top’ contact plate level may comprise contact plates that are partially stacked (i.e., overlapped in vertical direction) over contact plates among the bottom and/or middle contact plate levels. The middle contact plate level may be likewise partially stacked over the bottom contact plate level. Holes or gaps may be defined that permit respective contact tabs from each respective contact plate level among the middle and/or top contact plate levels to extend downwards so as to form welded connections to the battery cell terminals of respective P-Groups.

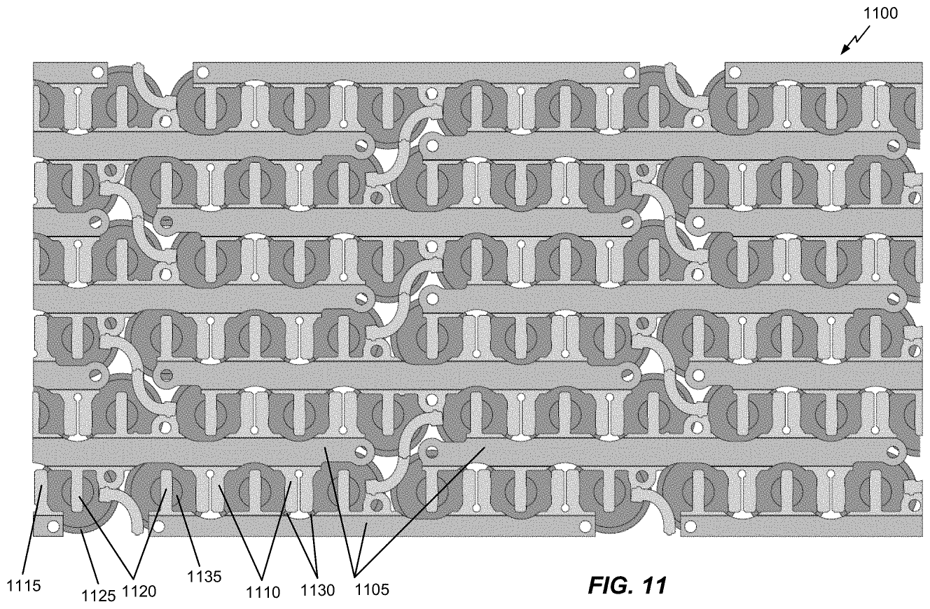

FIG. 11 illustrates a contact plate arrangement 1100 in accordance with another embodiment of the disclosure. In FIG. 11, a contact plate is arranged over a plurality of P-Groups and is comprised of a series of electrically inter-connected finger-shaped busbars 1105. The busbars 1105 are joined with negative bonding connectors 1110-1115 and positive bonding connectors 1120. The negative bonding connectors 1110-1115 are configured to form electrical connections (e.g., direct connections, or indirect connections where there is at least one intervening part) with negative cell rims 1125-1130. The positive bonding connectors 1120 are configured to form electrical connections (e.g., direct connections, or indirect connections where there is at least one intervening part) with positive cell heads 1135.

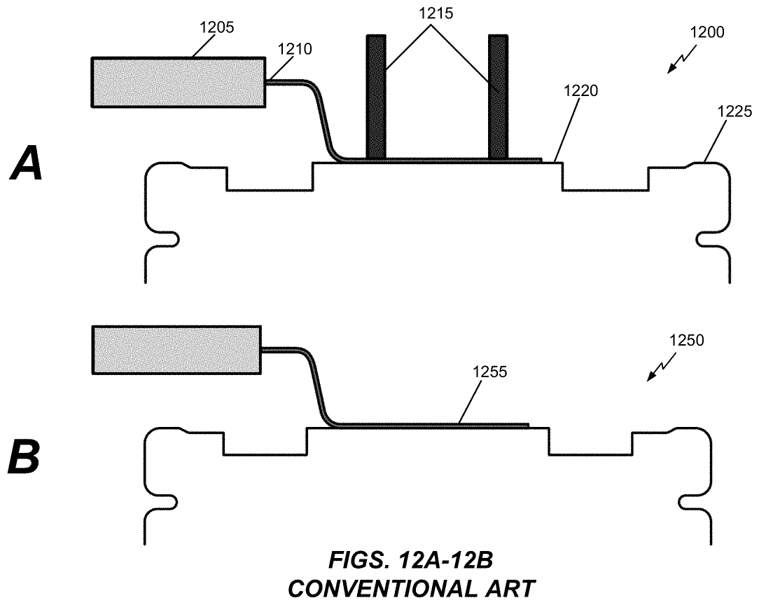

FIGS. 12A-12B illustrate conventional positive cell terminal connection configurations before and after welding of a respective bonding connector to a positive cell terminal of a battery cell. In particular, positive cell terminal connection configuration 1200 depicts a pre-welded state, and positive cell terminal connection configuration 1250 depicts a post-welded state. While a positive cell connection is shown in FIGS. 12A-12B, a negative cell connection may be implemented in a similar manner in other aspects.

Referring to FIG. 12A, a busbar (or contact plate) 1205 is configured with a bonding connector 1210 that is a non-sandwiched protruding part of a sandwiched cell terminal connection layer, as described above with respect to FIG. 5. A mechanical hold-down mechanism 1215 is used to press against the bonding connector 1210 against a positive cell head 1220. Also depicted is negative cell rim 1225. FIG. 12B depicts the bonding connector 1210 with a welded part 1255 after the mechanical hold-down mechanism 1215 is removed.

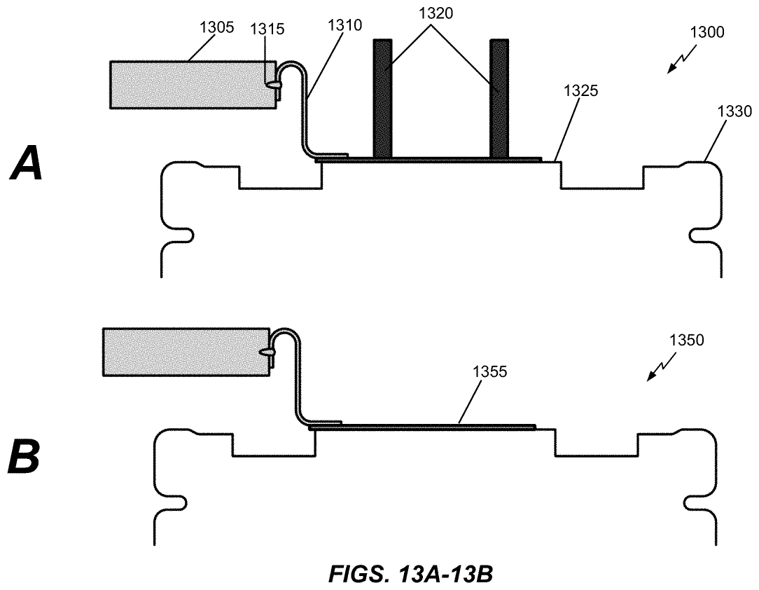

FIGS. 13A-13B illustrate positive cell terminal connection configurations before and after welding of a respective bonding connector to a positive cell terminal of a battery cell in accordance with an embodiment of the disclosure. In particular, positive cell terminal connection configuration 1300 depicts a pre-welded state, and positive cell terminal connection configuration 1350 depicts a post-welded state. While a positive cell connection is shown in FIGS. 13A-13B, a negative cell connection may be implemented in a similar manner in other aspects.

Referring to FIG. 13A, a busbar (or contact plate) 1305 is configured with a bonding connector 1310 that is attached to one of its respective sidewalls. In an example, tacking (e.g., laser tacking) may be implemented before the bonding connector 1310 is bent to help secure the bonding connector 1310 to the respective sidewall, as reflected by tack 1315. In other designs, tacking can be omitted, and other attachment mechanisms (e.g., gluing, welding, etc.) can be used to secure the bonding connector 1310 to the respective sidewall. In other designs, multiple attachment mechanisms can be used to secure the bonding connector 1310 to the respective sidewall (e.g., tacking and gluing, etc.).

Referring to FIG. 13A, a mechanical hold-down mechanism 1320 is used to press the bonding connector 1310 against a positive cell head 1325 (e.g., to secure the bonding connector 1310 during welding). Also depicted is negative cell rim 1330. FIG. 13B depicts the bonding connector 1310 with a welded part 1355 after the mechanical hold-down mechanism 1320 is removed.

Referring to FIG. 13A, in some designs, the busbar 1305 is implemented as a single-layer plate comprising a highly conductive material, such as aluminum, copper or an alloy thereof (e.g., to simplify construction). In some designs, the bonding connector 1310 may comprise a less conductive and more stable material (e.g., steel or Hilumin). In some designs, the material of the bonding connector 1310 may be selected so as to match a material of the positive cell head 1325.

Referring to FIG. 13A, in some designs, an average thickness of the busbar 1305 may preferentially range between about 0.5 mm to about 3.0 mm (e.g., at least, in the busbar section that interfaces with the bonding connector 1310; the busbar 1305 may have different thicknesses in other busbar sections). In some designs, an average thickness of the bonding connector 1310 may preferentially range between about 0.1 mm to about 0.3 mm. As will be described below in more detail, the bonding connector 1310 may include a fuse area that is altered relative to the rest of the bonding connector 1310 (e.g., via material extraction/removal, morphology, etc.) so as to have a lower fuse rating (e.g., a lower amperage/current or temperature at which the fuse area will break or fuse relative to the rest of the bonding connector). In some designs, the bonding connector 1310 may be thinner than the above-noted range in the fuse area.

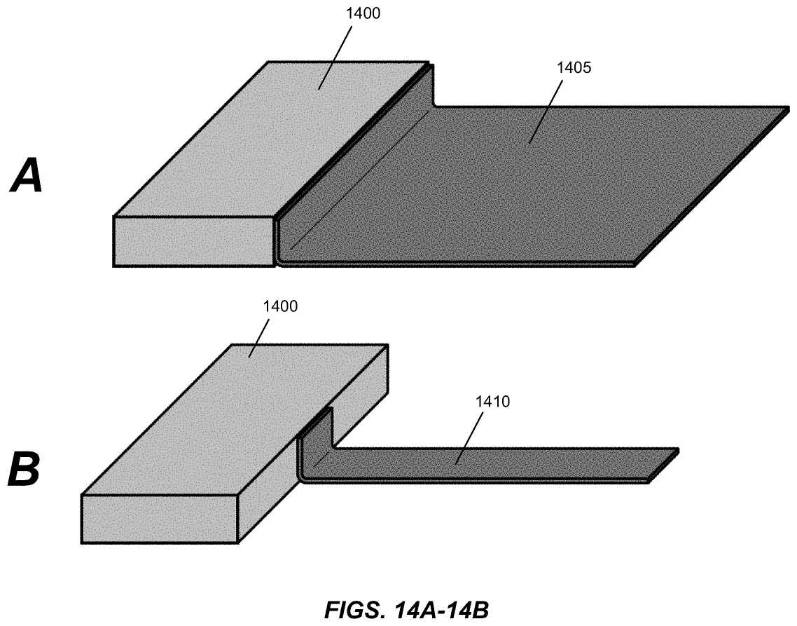

FIGS. 14A-14B illustrate an example of fabricating the arrangement of the busbar 1305 and bonding connector 1310 as shown in FIGS. 13A-13B in accordance with an embodiment of the disclosure. Referring to FIG. 14A, a busbar 1400 is joined with a metal part 1405 on one respective sidewall. Referring to FIG. 14B, the metal part 1405 is reduced (e.g., via stamping, cutting, etc.) to define a bonding connector 1410. In another embodiment, the bonding connector may be cut into the respective shape 1410 before it is joined with the busbar 1400.

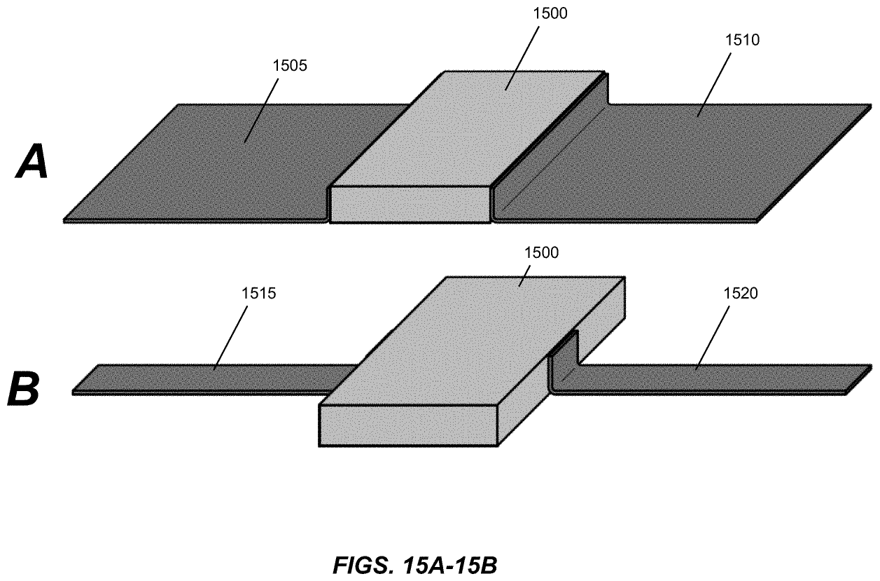

FIGS. 15A-15B illustrate an example of fabricating the arrangement of the busbar 1305 and bonding connector 1310 as shown in FIGS. 13A-13B in accordance with another embodiment of the disclosure. Referring to FIG. 15A, a busbar 1500 is joined with a first metal part 1505 on a first respective sidewall and is further joined with a second metal part 1510 on a second respective sidewall. Referring to FIG. 15B, the first metal part 1505 is reduced (e.g., via stamping, cutting, etc.) to define a first bonding connector 1515, and the second metal part 1510 is reduced (e.g., via stamping, cutting, etc.) to define a first bonding connector 1520. In another embodiment, the bonding connectors may be cut into the respective shapes 1515 and 1520 before being joined with the busbar 1500.

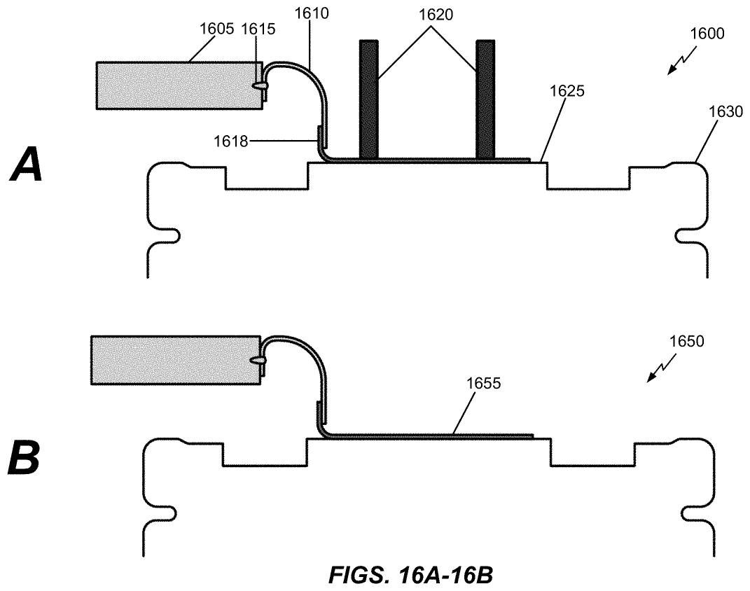

FIGS. 16A-16B illustrate positive cell terminal connection configurations before and after welding of a respective bonding connector to a positive cell terminal of a battery cell in accordance with another embodiment of the disclosure. In particular, positive cell terminal connection configuration 1600 depicts a pre-welded state, and positive cell terminal connection configuration 1650 depicts a post-welded state. While a positive cell connection is shown in FIGS. 16A-16B, a negative cell connection may be implemented in a similar manner in other aspects.

Referring to FIG. 16A, a busbar (or contact plate) 1605 is configured with a first bonding connector part 1610 that is attached to one of its respective sidewalls. In an example, tacking (e.g., laser tacking so as to produce a tack) or welding (e.g., laser welding so as to produce a welding seam) may be implemented before the first bonding connector part 1610 is bent to help secure the first bonding connector part 1610 to the respective sidewall, as reflected by tack or welding seam 1615. In other designs, tacking can be omitted, and other attachment mechanisms (e.g. brazing, gluing, welding, etc.) can be used to secure the first bonding connector part 1610 to the respective sidewall. In other designs, multiple attachment mechanisms can be used to secure the first bonding connector part 1610 to the respective sidewall (e.g., tacking and gluing, etc.).

Referring to FIG. 16A, a second bonding connector part 1618 is joined with the first bonding connector part 1610. A mechanical hold-down mechanism 1620 is used to press the second bonding connector part 1618 against a positive cell head 1625 (e.g., to secure the second bonding connector part 1618 during welding). Also depicted is negative cell rim 1630. FIG. 16B depicts the second bonding connector part 1618 with a welded part 1655 after the mechanical hold-down mechanism 1620 is removed.

Referring to FIG. 16A, in some designs, the busbar 1605 is implemented as a single-layer plate comprising a highly conductive material, such as aluminum, copper, or an alloy thereof (e.g., to simplify construction). In some designs, the first bonding connector part 1610 may comprise the same material as the busbar 1605 (e.g., aluminum, copper, or an alloy thereof). In some designs, the second bonding connector part 1618 may comprise a less conductive and more stable material (e.g., steel or Hilumin). In some designs, the material of the second bonding connector part 1618 may be selected so as to match a material of the positive cell head 1625.

Referring to FIG. 16A, in some designs, an average thickness of the busbar 1605 may preferentially range between about 0.5 mm to about 3.0 mm (e.g., at least, in the busbar section that interfaces with the first bonding connector part 1610; the busbar 1605 may have different thicknesses in other busbar sections). In some designs, an average thickness of the first bonding connector part 1610 may preferentially range between about 0.1 mm to about 0.3 mm. In some designs, an average thickness of the second bonding connector part 1618 may also preferentially range between about 0.1 mm to about 0.3 mm. As will be described below in more detail, the first bonding connector part 1610 may include a fuse area that is altered relative to the rest of the first bonding connector part 1610 (e.g., via material extraction/removal, morphology, etc.). In some designs, the first bonding connector part 1610 may be thinner than the above-noted range in the fuse area.

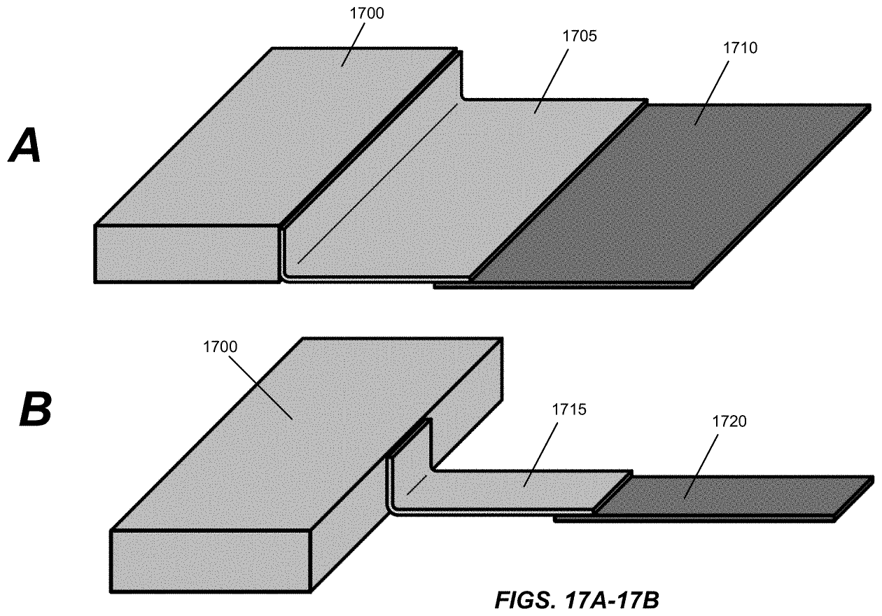

FIGS. 17A-17B illustrate an example of fabricating the arrangement of the busbar 1605 and bonding connector parts 1610 and 1618 as shown in FIGS. 16A-16B in accordance with an embodiment of the disclosure. Referring to FIG. 17A, a busbar 1700 is joined with a first metal part 1705 on one respective sidewall. The first metal part 1705 is in turn joined with a second metal part 1710. Referring to FIG. 17B, the first and second metal parts 1705-1710 are reduced (e.g., via stamping, cutting, etc.) to define a first bonding connector part 1715 and a second bonding connector part 1720. In another embodiment, the bonding connector may be cut into the respective shapes 1715 and 1720 before being joined with the busbar 1700.

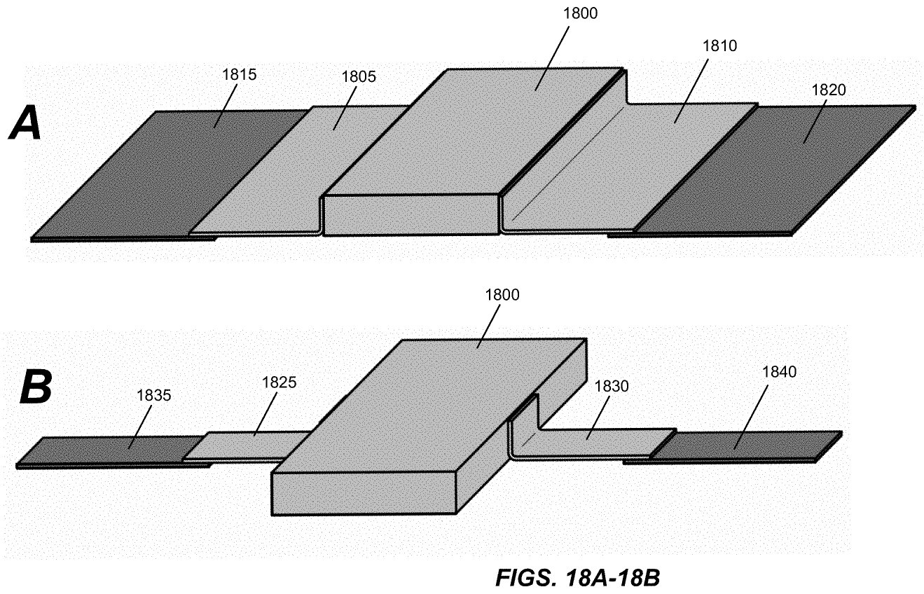

FIGS. 18A-18B illustrate an example of fabricating the arrangement of the busbar 1605 and bonding connector parts 1610 and 1618 as shown in FIGS. 16A-16B in accordance with another embodiment of the disclosure. Referring to FIG. 18A, a busbar 1800 is joined with a first metal part 1805 on a first respective sidewall and is further joined with a second metal part 1810 on a second respective sidewall. The first metal part 1805 is in turn joined with a third metal part 1815, and the second metal part 1810 is in turn joined with a fourth metal part 1820. Referring to FIG. 18B, the first metal part 1805 is reduced (e.g., via stamping, cutting, etc.) to define a first bonding connector part 1825, the second metal part 1810 is reduced (e.g., via stamping, cutting, etc.) to define a second bonding connector part 1830, the third metal part 1815 is reduced (e.g., via stamping, cutting, etc.) to define a third bonding connector part 1835, and the fourth metal part 1820 is reduced (e.g., via stamping, cutting, etc.) to define a fourth bonding connector part 1840. In another embodiment, the bonding connectors are cut into the respective shapes 1825, 1830, 1835, and 1840 before being joined with the busbar 1800.

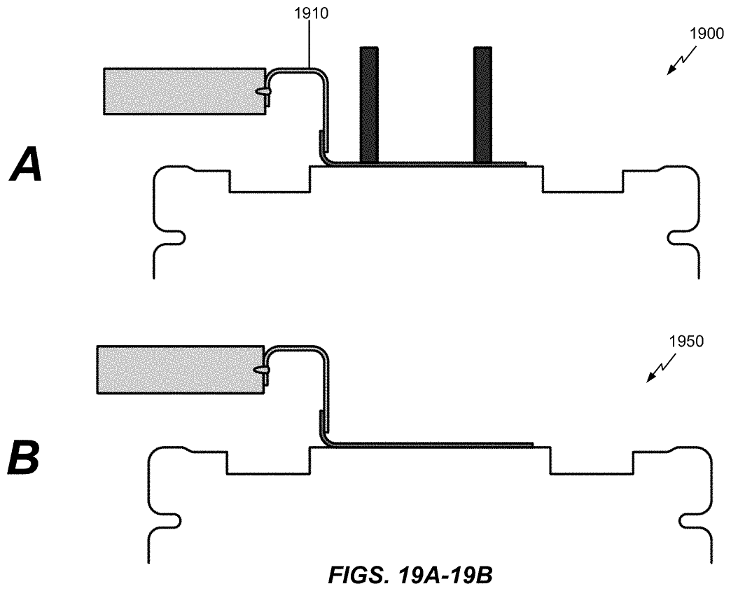

FIGS. 19A-19B illustrate positive cell terminal connection configurations before and after welding of a respective bonding connector to a positive cell terminal of a battery cell in accordance with another embodiment of the disclosure. In particular, positive cell terminal connection configuration 1900 depicts a pre-welded state, and positive cell terminal connection configuration 1950 depicts a post-welded state. While a positive cell connection is shown in FIGS. 19A-19B, a negative cell connection may be implemented in a similar manner in other aspects.

The positive cell terminal connection configurations 1900 and 1950 are similar to the positive cell terminal connection configurations 1600 and 1650, respectively, of FIG. 16 except for the shape of the first bonding connector part 1610. In the positive cell terminal connection configurations 1600 and 1650 of FIG. 16, the first bonding connector part 1610 is bent with a middle section that is curved continuously. By contrast, a first bonding connector part 1910 as shown in FIGS. 19A-19B is bent so as to define two substantially flat sections.

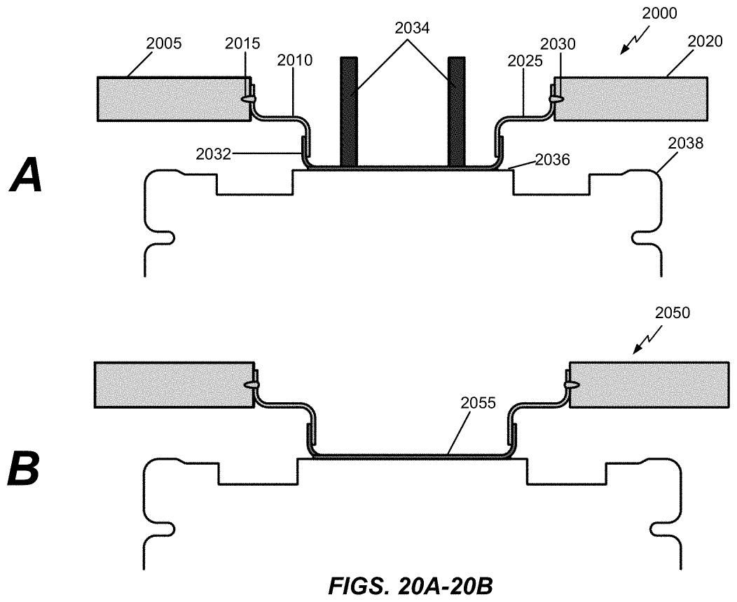

FIGS. 20A-20B illustrate positive cell terminal connection configurations before and after welding of a respective bonding connector to a positive cell terminal of a battery cell in accordance with another embodiment of the disclosure. In particular, positive cell terminal connection configuration 2000 depicts a pre-welded state, and positive cell terminal connection configuration 2050 depicts a post-welded state. While a positive cell connection is shown in FIGS. 20A-20B, a negative cell connection may be implemented in a similar manner in other aspects.

Referring to FIG. 20A, a busbar (or contact plate) 2005 is configured with a first bonding connector part 2010 that is attached to one of its respective sidewalls. In an example, tacking (e.g., laser tacking so as to produce a tack) or welding (e.g., laser welding so as to produce a welding seam) may be implemented before the first bonding connector part 2010 is bent to help secure the first bonding connector part 2010 to the respective sidewall, as reflected by tack or welding seam 2015. In other designs, tacking can be omitted, and other attachment mechanisms (e.g., gluing, welding, etc.) can be used to secure the first bonding connector part 2010 to the respective sidewall. In other designs, multiple attachment mechanisms can be used to secure the first bonding connector part 2010 to the respective sidewall (e.g., tacking and gluing, etc.).

Referring to FIG. 20A, a busbar (or contact plate) 2020 is configured with a second bonding connector part 2025 that is attached to one of its respective sidewalls. In an example, tacking (e.g., laser tacking so as to produce a tack) or welding (e.g., laser welding so as to produce a welding seam) may be implemented before the second bonding connector part 2025 is bent to help secure the second bonding connector part 2025 to the respective sidewall, as reflected by tack or welding seam 2030. In other designs, tacking can be omitted, and other attachment mechanisms (e.g., gluing, welding, etc.) can be used to secure the second bonding connector part 2025 to the respective sidewall. In other designs, multiple attachment mechanisms can be used to secure the second bonding connector part 2025 to the respective sidewall (e.g., tacking and gluing, etc.).

Referring to FIG. 20A, in some designs, the busbar 2005 and busbar 2020 may correspond to different parts of the same busbar. In other designs, the busbar 2005 and busbar 2020 may correspond to different busbars that are connected in parallel with each other.

Referring to FIG. 20A, a third bonding connector part 2032 is joined with both the first bonding connector part 2010 and the second bonding connector part 2025. A mechanical hold-down mechanism 2034 is used to press the third bonding connector part 2032 against a positive cell head 2036 (e.g., to secure the third bonding connector part 2032 during welding). Also depicted is negative cell rim 2038. FIG. 20B depicts the third bonding connector part 2032 with a welded part 2055 after the mechanical hold-down mechanism 2034 is removed.

Referring to FIG. 20A, in some designs, the busbar(s) 2005 and 2020 are implemented as single-layer plate(s) comprising a highly conductive material, such as aluminum, copper, or an alloy thereof (e.g., to simplify construction). In some designs, the first and second bonding connector parts 2010 and 2025 may comprise the same material as the busbar(s) 2005 and 2020 (e.g., aluminum, copper, or an alloy thereof). In some designs, the third bonding connector part 2032 may comprise a less conductive and more stable material (e.g., steel or Hilumin). In some designs, the material of the third bonding connector part 2032 may be selected so as to match a material of the positive cell head 2036.

In some designs, a multi-connection bonding connector as depicted in FIGS. 20A-20B may provide one or more technical advantages, such as reducing a resistance between the positive cell head 2036 and the busbar(s) 2005 and 2020, decreasing a risk of a short-circuit, etc.

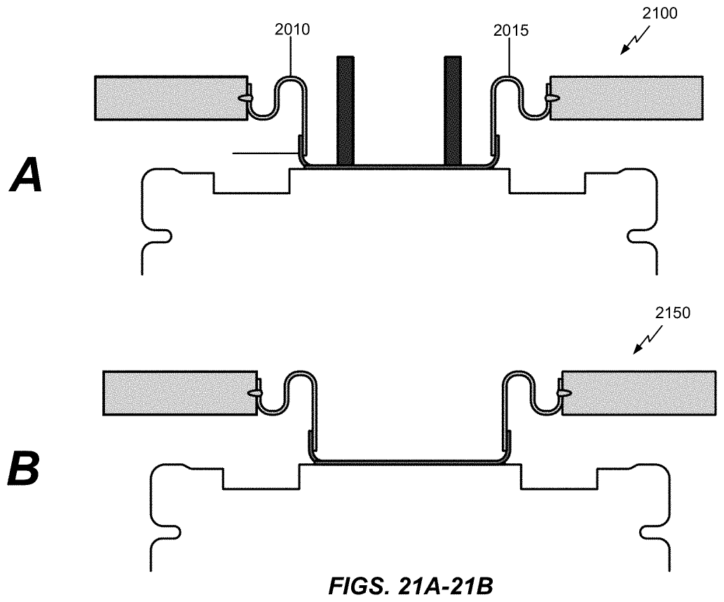

FIGS. 21A-21B illustrate positive cell terminal connection configurations before and after welding of a respective bonding connector to a positive cell terminal of a battery cell in accordance with another embodiment of the disclosure. In particular, positive cell terminal connection configuration 2100 depicts a pre-welded state, and positive cell terminal connection configuration 2150 depicts a post-welded state. While a positive cell connection is shown in FIGS. 21A-21B, a negative cell connection may be implemented in a similar manner in other aspects.

The positive cell terminal connection configurations 2100 and 2150 are similar to the positive cell terminal connection configurations 1900 and 1950, respectively, of FIG. 19 except for the shape of the first and second bonding connector parts 2005 and 2020. In the positive cell terminal connection configurations 1900 and 1950 of FIG. 19, the first and second bonding connector parts 2005 and 2020 are each bent in a manner that defines a relatively flat middle section. By contrast, first and second bonding connector parts 2105 and 2120 as shown in FIGS. 21A-21B are bent in a wave-like (or sinusoidal) manner with multiple points of curvature.

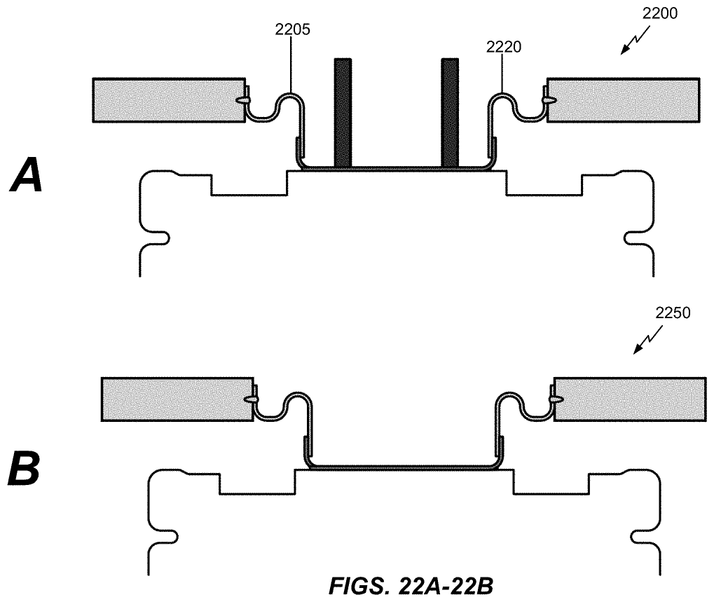

FIGS. 22A-22B illustrate positive cell terminal connection configurations before and after welding of a respective bonding connector to a positive cell terminal of a battery cell in accordance with another embodiment of the disclosure. In particular, positive cell terminal connection configuration 2200 depicts a pre-welded state, and positive cell terminal connection configuration 2250 depicts a post-welded state. While a positive cell connection is shown in FIGS. 22A-22B, a negative cell connection may be implemented in a similar manner in other aspects.

The positive cell terminal connection configurations 2200 and 2250 are similar to the positive cell terminal connection configurations 2100 and 2150, respectively, of FIG. 21A except for the shape of the first and second bonding connector parts 2105 and 2120. In FIG. 22A, first and second bonding connector parts 2205 and 2220 are bent in a wave-like (or sinusoidal) manner with multiple points of curvature but with a shorter wave relative to the first and second bonding connector parts 2105 and 2120 as shown in FIGS. 21A-21B.

It will be appreciated that FIGS. 19A-22B depict variations of the bonding connector parts described above with respect to FIGS. 16A-16B. The exemplary ranges in terms of thickness of the various components (e.g., busbars, bonding connector parts, etc.) described above with respect to FIGS. 16A-16B likewise apply to the corresponding parts depicted in FIGS. 19A-22B.

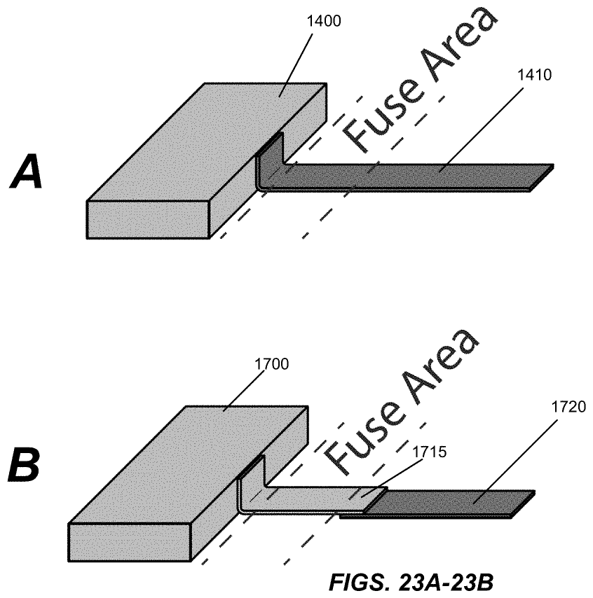

FIGS. 23A-23B depict the busbar arrangements from FIGS. 14B and 17B, respectively, in accordance with embodiments of the disclosure. In FIGS. 23A-23B, the busbar arrangements from FIGS. 14B and 17B are shown with respective defined fuse areas. Generally, the respective defined fuse areas are designed to break first in response to a surge in current across the respective bonding connector. The fuse area can be defined in a variety of ways. In some designs, part of the material in the fuse area can be removed (e.g., via stamping, punching, etching, cutting, etc.) to define the fuse area.

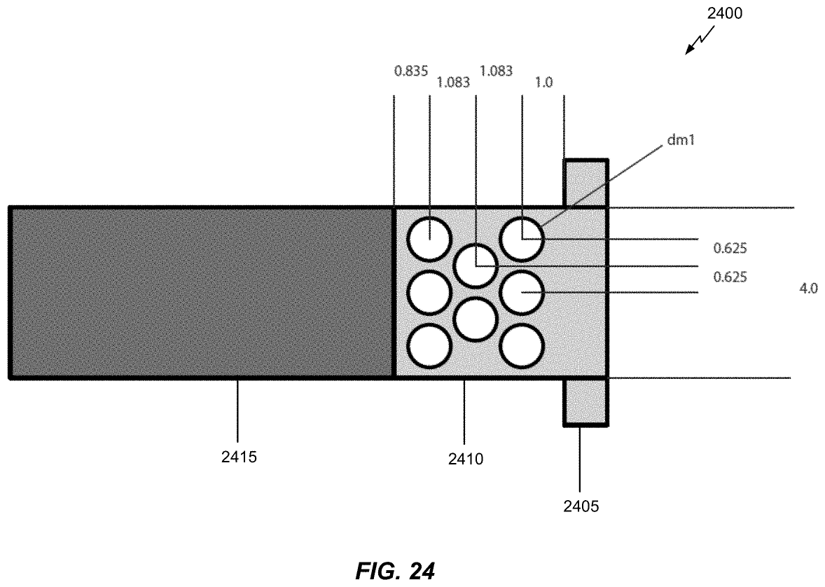

FIG. 24 illustrates a bonding connector 2400 with a busbar interface part 2405 (e.g., tacked or glued to a respective sidewall of a busbar), a fuse area 2410 and a non-fuse area 2415. In FIG. 24, the fuse area 2410 is punched or stamped with eight holes. The distance measurements depicted in FIG. 24 are provided in units of millimeters (mm).

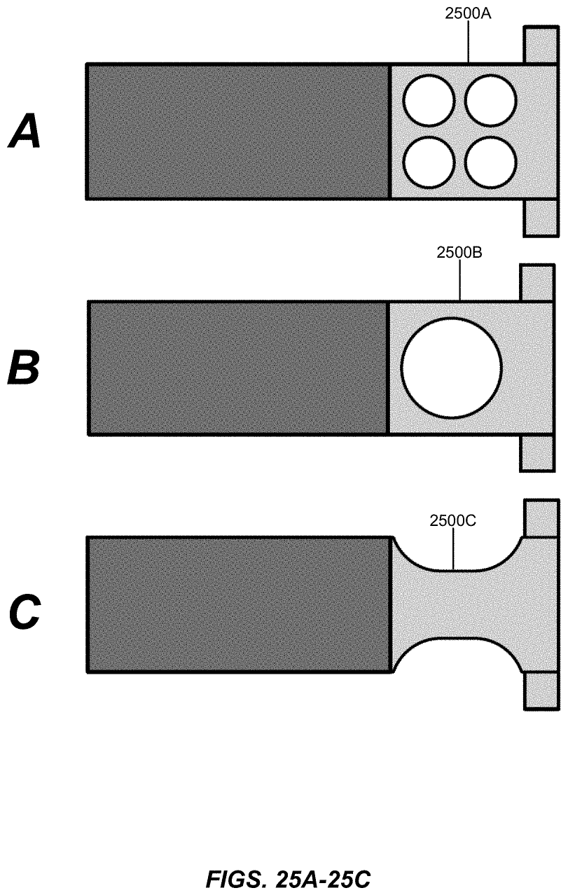

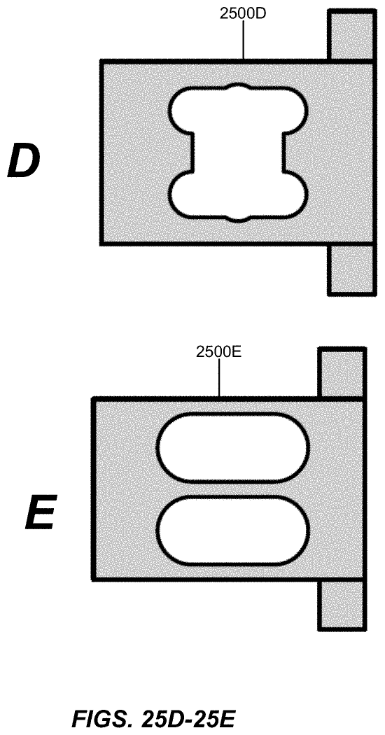

FIGS. 25A-25E illustrate alternative fuse areas in accordance with embodiments of the disclosure. In FIG. 25A, a fuse area 2500A is defined via four larger holes (relative to the eight holes that define the fuse area 2410 of FIG. 24). In FIG. 25B, a fuse area 2500B is defined via a single large hole. In FIG. 25C, a fuse area 2500C is defined via a narrowed out section whereby material is removed from opposing sides of the bonding connector. In FIG. 25D, a fuse area 2500D is defined via a single large punched or stamped non-circular section. In FIG. 25E, a fuse area 2500E is defined via two punched or stamped obround or stadium-shaped sections. While not shown expressly in FIGS. 24A-25E, a fuse area may also be defined (e.g., in a respective sheet metal part of a bonding connector) in part via a thinned out section that is thinner than a remainder of a respective bonding connector. In some designs, this ‘thinned out’ fuse area may be deployed on its own, or alternatively in conjunction with any of the fuse area configurations depicted in FIGS. 24A-25E (e.g., a thinned out fuse area that is further punched/stamped, a thinned out fuse area that is also narrowed at respective sides, etc.).

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A contact plate arrangement for a battery module, comprising:
a busbar configured to transport current between first and second parallel groups of battery cells (P-Groups) in series; and
a bonding connector attached to a sidewall of the busbar and configured to form an electrical connection with a cell terminal of a battery cell from a respective one of the first and second P-Groups.

2. The contact plate arrangement of claim 1,
wherein the busbar comprises a first material, and
wherein the bonding connector comprises a second material that is different than the first material.

3. The contact plate arrangement of claim 2, wherein the first material has a higher conductivity relative to the second material.

4. The contact plate arrangement of claim 3,
wherein the first material comprises aluminum, copper, or an alloy thereof, and
wherein the second material comprises steel.

5. The contact plate arrangement of claim 1,
wherein the busbar comprises a first material, and
wherein the bonding connector comprises a first bonding connector part that comprises the first material, and
wherein the bonding connector comprises a second bonding connector part that comprises a second material that is different than the first material.

6. The contact plate arrangement of claim 5,
wherein the first bonding connector part is attached to the sidewall of the busbar, and
wherein the second bonding connector part is attached to the first bonding connector part, and
wherein the second bonding connector part is further configured to be attached to the cell terminal of the battery cell.

7. The contact plate arrangement of claim 5, wherein the first material has a higher conductivity relative to the second material.

8. The contact plate arrangement of claim 7,
wherein the first material comprises aluminum, copper, or an alloy thereof, and
wherein the second material comprises steel.

9. The contact plate arrangement of claim 5, wherein the first bonding connector part is arranged with a fuse area that has a lower fuse rating relative to the second bonding connector part.

10. The contact plate arrangement of claim 1, wherein the bonding connector is arranged with a homogeneous material composition.

11. The contact plate arrangement of claim 1, wherein the bonding connector is arranged with a plurality of bonding connector parts that each include a different material composition.

12. The contact plate arrangement of claim 1, wherein the bonding connector is arranged with a fuse area that has a lower fuse rating relative to a remainder of the bonding connector.

13. The contact plate arrangement of claim 1, wherein the cell terminal is a positive cell terminal of the battery cell.

14. The contact plate arrangement of claim 1, wherein the cell terminal is a negative cell terminal of the battery cell.

15. The contact plate arrangement of claim 1, wherein the bonding connector is further configured to form at least one additional electrical connection with at least one additional cell terminal of at least one additional battery cell from the respective P-Group.

16. The contact plate arrangement of claim 1,
wherein the bonding connector comprises a first bonding connector part attached to the sidewall of the busbar, and
wherein the bonding connector further comprises a second bonding connector part attached to the first bonding connector part and to the cell terminal of the battery cell.

17. The contact plate arrangement of claim 16, wherein the bonding connector comprises a third bonding connector part attached to the first bonding connector part and to either (i) another part of the sidewall of the busbar, or (ii) a sidewall of a different busbar that is connected in parallel with the busbar.

18. The contact plate arrangement of claim 17,
wherein the busbar comprises a first material, and
wherein the first and third bonding connector parts comprise the first material, and
wherein the second bonding connector part comprises a second material that is different than the first material.

19. The contact plate arrangement of claim 18, wherein the first material has a higher conductivity relative to the second material.

20. The contact plate arrangement of claim 19,
wherein the first material comprises aluminum, copper, or an alloy thereof, and
wherein the second material comprises steel.
